(19) United States
(12) Patent Application Publication
(10) Pub. No.: US 2026/0238079 A1
(43) Pub. Date: Aug. 13, 2026

(54) DRIVE MOTOR AND SWIVEL ACTUATOR USING SAME

(71) Applicant: AMOTECH CO., LTD, Incheon (KR)

(72) Inventors: Byung Soo KIM, Incheon (KR); Jong Hwa SHIN, Incheon (KR)

(21) Appl. No.: 19/104,689

(22) PCT Filed: Aug. 22, 2023
(86) PCT No.: PCT/KR2023/012399

§ 371 Date: Feb. 18, 2025

(30) Foreign Application Priority Data
Aug. 29, 2022 (KR) 10-2022-0108243

(51) Int. Cl. H02K 7/08; B60N 2/02; B60N 2/14; F16H 57/021; H02K 1/2753; H02K 5/16; H02K 7/116

(52) U.S. Cl. CPC H02K 7/081; B60N 2/02253; H02K 1/2753; H02K 5/16; H02K 7/1166; B60N 2/14; F16H 2057/0213

(57) ABSTRACT

Provided are a drive motor and a swivel actuator using same, which are capable of applying a preload to a bearing by positioning a magnet of a rotor in an asymmetric structure above a stator core. The drive motor for a seat actuator includes: a housing having a hollow cylindrical portion protruding from a bottom thereof at a center thereof; a rotor having a rotor support having a cup shape at a lower end portion thereof, and rotatably coupled to an outer periphery of the hollow cylindrical portion; a stator which is arranged on the outer side of the rotor with an air gap, generates a rotating magnetic field, and is arranged on the bottom of the housing to rotate the rotor; first and second bearings arranged between the cup-shaped lower end portion of the rotor support and a lower end portion of the hollow cylindrical portion to rotatably support the rotor, and stacked in series; and a bearing support press-coupled to the outer periphery of the hollow cylindrical portion to press the second bearing.

### TECHNICAL FIELD

The present invention relates to a swivel actuator, and especially to a drive motor capable of applying a preload to a bearing by positioning a magnet of a rotor in an asymmetric structure above a stator core, and a swivel actuator using same.

### BACKGROUND ART

An electric actuator rotates or linearly moves a passive object to be driven with a high torque rotational force obtained by torque conversion of the rotational force generated from a rotating power source.

In general, the actuator has a low height of the housing as a whole product in use, and one of the horizontal and the vertical is configured to have a long shape. Accordingly, it is difficult to employ a structure in which a DC motor having an outer casing is vertically mounted on the inner bottom of the housing.

In the case of using a DC motor, the brake torque should be increased by using a worm gear because a stationary position should be kept when external pressure is applied on the output shaft that rotates forward and reverse.

To use a worm gear and a worm wheel in a DC motor and to deliver power to the position where the output shaft is located, the connection therebetween is usually formed using a spur gear, in which case the following problems exist.

First, since the housing height of the actuator is low, there is a problem in that a DC motor is generally laid and applied, and thus an assembly structure is difficult and a unit cost is increased. That is, there is a problem in securing an assembly space due to the casing of the DC motor and the bearing that needs to hold the worm shaft.

Second, the structure of connecting the motor power to a motor controller becomes complicated.

Third, rotational position information of the rotor is required for accurate position control in the actuator. To this end, since a rotational position sensing magnet is arranged at the bottom of a warm gear of a DC motor and a rotational position sensing Hall sensor integrated circuit (IC) is applied, the structure of connecting a Hall sensor to a PCB is complicated to use DC power and to sense the rotational position.

Fourth, in a gear train that uses multiple spur gears to obtain a large reduction ratio, the tolerance the rotating power of the drive motor increases, resulting in a large backlash and difficulty in controlling the precise position.

Meanwhile, in recent years, a swivel actuator has been used to rotate a main body of a driven object (i.e., a car seat) from side to side along with a rotary table as an actuator for rotating a vehicle car seat from side to side.

Considering that conventional actuators use direct-current (DC) motors lying inside low-height housing, a swivel actuator with a compact and slim structure, by installing a core motor-type brushless direct-current (BLDC) motor vertically on the bottom of the housing and installing a reduction gear train on the top thereof is proposed in Korean Patent Application Publication No. 10-2022-0056821 (Patent Document 1).

The swivel actuator of Patent Document 1 also proposes a structure of rotating a rotary table by a power transmission structure capable of minimizing backlash, by a gear train change structure of minimizing the number of coupling gears, by integrally forming a worm wheel and a worm gear at intervals on a power transmission shaft.

However, since the swivel actuator of Patent Document 1 is a structure that transmits rotational power using one gear train between the BLDC motor and the pinion gear unit driving the rotary table, the tolerance between gears may be reduced, but not completely reduced, and the brake torque that controls the left and right rotation of the driven object main body (i.e., car seat) that rotates with the rotary table is low, making it impossible to suppress vibration generation.

### DISCLOSURE

### Technical Problem

The present invention has been made in an effort to solve the defects of the conventional technology, and thus it is an objective of the present invention to provide a swivel actuator capable of increasing destructive strength by increasing brake torque while minimizing backlash by employing a double worm structure at both end portions of a power transmission shaft of a first gear train and a second gear train, thereby coupling four pinion gear units to four worm gears and thus transmitting decelerated rotating power at four points of a ring gear of the rotary table.

It is another objective of the present invention to provide a swivel actuator capable of removing tolerance generated when coupling between gears and enabling a backlash to be zero by suppressing left and right displacements in a bearing housing by using a set screw on both end portions of a power transmission shaft of first and second gear trains.

It is another objective of the present invention to provide a drive motor and a swivel actuator using same, which may promote verticality and dimensional stability when a rotor rotates by stacking a pair of lower bearings in series to rotatably support the rotor.

It is another objective of the present invention to provide a drive motor and a swivel actuator using same, which apply a preload to a bearing by twisting inner and outer races of a bearing, by using the force which causes the inner race of the bearing integrally formed with a rotor to move downward by an attractive force acting between a magnet of the rotor and a stator core, by positioning the magnet of the rotor in an asymmetric structure upward from the stator core.

It is another objective of the present invention to provide a drive motor and a swivel actuator using same, which may fix lower and upper bearings and prevent separation of a rotor worm gear formed on an extension portion of a rotor, by using a bearing support press-fitted to a hollow cylindrical portion protruding upward from a lower housing.

### Technical Solution

In order to achieve the above objectives, according to an aspect of the present invention, there is provided a drive motor for a swivel actuator including: a housing having a hollow cylindrical portion protruding from a bottom thereof at a center thereof; a rotor having a rotor support having a cup shape at a lower end portion thereof, and rotatably coupled to an outer periphery of the hollow cylindrical portion; a stator which is arranged on the outer side of the rotor with an air gap, generates a rotating magnetic field, and is arranged on the bottom of the housing to rotate the rotor; first and second bearings arranged between the cup-shaped lower end portion of the rotor support and a lower end portion of the hollow cylindrical portion to rotatably support the rotor, and stacked in series; and a bearing support press-coupled to the outer periphery of the hollow cylindrical portion to press the second bearing.

The rotor support includes: an inner concave groove provided inside the lower end portion thereof to serve as a bearing housing for accommodating the first and second bearings; and an outer concave groove formed outside the lower end portion thereof to serve as a support for accommodating a back yoke and a magnet of the rotor, wherein each of the first and second bearings may be configured as a ball bearing in which an inner race is supported by the hollow cylindrical portion and an outer race is supported in the inner concave groove.

In this case, the bearing support may be pressed and coupled to an outer periphery of the hollow cylindrical portion to compress the inner race of the second bearing.

In addition, a preload may be applied to the first and second bearings by positioning the magnet of the rotor in an asymmetric structure upward by a predetermined height from the stator core.

The drive motor for the swivel actuator according to the present invention may further include a rotor worm gear separation prevention protrusion protruding from the upper end portion of the bearing support to prevent the rotor from separating from the first and second bearings and making contact with the third bearing.

In addition, the drive motor for the swivel actuator according to the present invention may further include a rotor worm gear integrally formed on the upper portion of the rotor support extending above the rotor.

According to another aspect of the present invention, there is provided a swivel actuator including: a lower housing with a hollow cylindrical portion protruding upward in the center thereof, which serves as a support shaft of the rotor; an upper housing stacked and assembled on an upper portion of the lower housing and having a through hole formed in a central portion thereof in which the hollow cylindrical portion protrudes upward through the through hole; a drive motor which is arranged on a bottom surface of the lower housing and has a rotor worm gear integrally formed on an outer periphery of a cylindrical extension portion of the rotor support extending to an upper portion of the through hole; first and second gear trains, each being arranged at intervals of 180 degrees at the outer periphery of the rotor worm gear protruding to the upper housing and being coupled thereto, having, in the middle of first and second power transmission shafts, first and second worm wheels gear-coupled to the rotor worm gear, and having first to fourth worm gears formed at both sides of each of the first and second power transmission shafts; first to fourth pinion gear units in which third to sixth worm wheels gear-coupled to the first to fourth worm gears are formed at the lower end portions of first to fourth support shafts, respectively, and first to fourth pinion gears are formed on the upper end portions of the first to fourth support shafts, respectively; a rotary table gear-coupled to a ring gear having the first to fourth pinion gears integrally formed on the inner side of the side surface portion thereof, so as to rotate; first and second bearings arranged between the cup-shaped lower end portion of the rotor support and a lower end portion of the hollow cylindrical portion to rotatably support the rotor, and stacked in series; and a third bearing rotatably supporting the rotary table on an outer periphery of an upper end portion of the hollow cylindrical portion.

The first and second gear trains may include: first and second power transmission shafts arranged to face each other at intervals of 180 degrees on the outer periphery of the rotor worm gear; first and second worm wheels that are gear-coupled to the rotor worm gear in the middle portions of the first and second power transmission shafts; and first to fourth worm gears formed on one side and the other side of each of the first and second power transmission shafts.

In addition, the first and second power transmission shafts each may further include: a pair of bearings installed in first and second concave grooves of the upper housing respectively to rotatably support both end portions; a pair of bearing housings that accommodate and support the pair of bearings; a pair of set screw assembly units formed to extend from the rear end portions of the pair of bearing housings; and a pair of set screws which are screw-coupled to the set screw assembly units so that front end portions thereof support end portions of the power transmission shafts. The set screws may suppress axial displacement of the first and second power transmission shafts by pushing and fixing the first and second power transmission shafts to one side from the outside through set screw adjustment through holes formed in the upper housing.

The cylindrical extension portion extending to the upper portion of the rotor and the cylindrical first worm gear may be vertically set on the bottom surface of the lower housing, and the first and second power transmission shafts may be installed in a horizontal direction orthogonal to the axis of the cylindrical rotor worm gear, and the first to fourth support shafts may be installed in a vertical direction orthogonal to the first and second power transmission shafts, respectively.

In addition, the rotary table includes: a top plate on which a car seat is installed, and which is equipped with a through hole in the center where the upper end portion of the hollow cylindrical portion of the lower housing is located; a side surface portion extending downward from an outer circumferential portion of the upper plate; and a ring gear integrally formed inside the side surface portion, wherein the first to fourth pinion gears of the first to fourth pinion gear units may be gear-coupled to the ring gear of the rotary table at four points.

The swivel actuator according to the present invention may further include a bearing support that is pressed and coupled to the outer periphery of the hollow cylindrical portion to compress the second bearing.

In addition, the drive motor includes: a rotor provided with a rotor support which is rotatably coupled to the outer periphery of the cylindrical portion and has a lower end portion which is formed in a cup shape; and a stator arranged on the bottom of the lower housing outside the rotor, to rotate and drive the rotor, wherein the swivel actuator may further include: a lower bearing arranged between the cup-shaped lower end portion of the rotor support and a lower end portion of the hollow cylindrical portion of the housing to rotatably support the rotor; and an upper bearing rotatably supporting the rotary table on an outer periphery of the hollow cylindrical portion.

The stator coil of the drive motor and the cable for connecting the plurality of Hall sensors in the Hall sensor assembly with the motor driving circuit installed outside the swivel actuator may be connected through a central through hole in the center of the top plate and a hollow cylindrical portion of the lower housing.

The upper housing may include first and second concave grooves accommodating the first and second gear trains and the first to fourth pinion gear units.

In this case, when the rotor and the first worm gear of the drive motor rotate clockwise, the first and second power transmission shafts may rotate counterclockwise, and the rotary table may rotate clockwise.

In addition, both end portions of each of the first and second power transmission shafts are rotatably supported by bearings, and a plurality of set screws may be installed in the bearing housing in which the bearings are embedded to suppress the occurrence of left and right displacements of the first and second power transmission shafts.

### Advantageous Effects

As described above, in the present invention, a worm wheel and a worm gear are integrally formed at intervals on a power transmission shaft to provide a power transmission structure capable of minimizing backlash by a gear train change structure in which the number of coupling gears is minimized. As a result, the present invention may reduce overall size and secure a space compared to a conventional gear train in which a plurality of spur gears are combined, thereby increasing degree of freedom in design and reducing costs.

In addition, according to the present invention, a BLDC drive motor is installed on the bottom of a housing, and first and second gear trains, in which a worm wheel and a worm gear are integrally formed at intervals on a power transmission shaft, are arranged in a symmetrical structure in the housing, thereby minimizing backlash and simultaneously suppressing vibration generation of the rotary table.

Moreover, in this invention, the BLDC drive motor is installed on the bottom of the housing, the worm wheels of the first and second gear trains are arranged in a symmetrical structure on the outer periphery of the cylindrical rotor worm gear of the drive motor, and four pinion gear units are combined with the four worm gears formed at both end portions of the first and second gear trains to be combined with the ring gear of the rotary table at four points, thereby minimizing backlash and suppressing the vibration generation of the rotary table.

In addition, the swivel actuator according to the present invention may employ a double worm structure at both end portions of the power transmission shaft of each of the first gear train and the second gear train, thereby coupling four pinion gear units to four worm gears and thus driving a rotary table, and thus transmitting the decelerated rotational force to the ring gear of the rotary table at four points, to accordingly increase the fracture strength by increasing the brake torque while minimizing the backlash.

As described above, when the first and second gear trains are arranged in a symmetrical structure inside the housing, it is possible to reduce a tolerance between gears, but it is difficult to completely reduce the tolerance. In other words, the gap between the gears is minimized, but the tolerance between the gears occurs, resulting in a gap between the gears, which may cause a passive body (e.g., the rotary table) gear-coupled with the pinion gear unit to shake left and right.

This problem may be caused by the occurrence of the left and right (i.e., axial) displacement of both end portions of the power transmission shafts forming the gear train in the bearing housing. Accordingly, in the present invention, a set screw screw-coupled to a set screw assembly unit formed to extend to the rear end portion of the bearing housing is added to suppress occurrence of left and right displacement of both end portions of the power transmission shafts in the bearing housing, and axial displacement of the first and second power transmission shafts may be suppressed by pushing and fixing the first and second power transmission shafts to one side by tightening the set screw from the outside through set screw adjustment through holes formed in the housing.

As a result, by suppressing the left and right displacement of the first and second power transmission shafts, the tolerance (gap) that occurs when the gears are coupled between the worm gear of the gear train and the worm wheel of the pinion gear unit is eliminated, and as a result, the gap between the pinion gear of the pinion gear unit and the ring gear of the passive body (e.g., the rotary table) may be removed to zero the backlash.

In addition, in this invention, verticality and dimensional stability may be achieved when the rotor is rotated by stacking a pair of lower bearings in series to support the rotor rotatably.

Furthermore, in the present invention, a preload may be applied to a bearing by twisting inner and outer races of a bearing, by using the force which causes the inner race of the bearing integrally formed with a rotor to move downward by an attractive force acting between a magnet of the rotor and a stator core, by positioning the magnet of the rotor in an asymmetric structure upward from the stator core. As a result, the preload may be applied to the bearing, thereby increasing the reliability of the bearing and reducing noise.

In addition, in the present invention, the lower and upper bearings may be fixed using the bearing support that is press-fitted into a hollow cylindrical portion protruding upward from the lower housing, and at the same time, the rotor worm gear formed on the rotor extension portion may be prevented from being separated.

### BRIEF DESCRIPTION OF THE DRAWINGS

FIGS. 1 to 3A are a perspective view, a plan view, and a cross-sectional view taken along line A-A of FIG. 2, respectively, of a hollow swivel actuator according to a preferred embodiment of the present invention.

FIG. 3B is a half (½) enlarged view of an axial cross section of a hollow swivel actuator according to a preferred embodiment of the present invention.

FIGS. 4 and 5 are an exploded perspective view illustrating that a rotary table is separated from a hollow swivel actuator according to a preferred embodiment of the present invention, and a plan view of FIG. 4 in which the rotary table has been removed, respectively.

FIGS. 6A to 6C are cross-sectional views taken along line B-B, line C-C, and line D-D of FIG. 5, respectively.

FIGS. 7 and 8 are a module-each exploded perspective view and a fully exploded perspective view of a hollow swivel actuator according to a preferred embodiment of the present invention, respectively.

FIG. 9 is an exploded perspective view illustrating an upper portion of a rotary table has been removed from a hollow swivel actuator according to a preferred embodiment of the present invention.

### BEST MODE FOR CARRYING OUT THE INVENTION

Hereinafter, embodiments of the present invention will be described in detail with reference to the accompanying drawings.

The sizes and shapes of the components shown in the drawings may be exaggerated for clarity and convenience. In addition, terms defined in consideration of the configuration and operation of the present invention may vary depending on the intention or custom of the user, the operator, and the like. Definitions of these terms should be based on the content of this specification.

A swivel actuator according to the present invention is used for rotating a passive object main body, that is, a car seat for a vehicle to the left and right together with a rotational table. In the following description, a hollow swivel actuator for driving a passive object by using a BLDC-type drive motor as a power source is described.

It is difficult to apply a BLDC motor to a general motor, but in this invention, the BLDC motor is vertically erected and the size of the BLDC motor in a radial direction is increased to increase motor torque. The drive motor has a stator and a rotor arranged on the bottom surface of the housing, and uses an inner rotor type BLDC motor.

An actuator according to the conventional art includes a motor portion made of a DC motor, a gear part, and a rotating part, which are configured as separate components, so when assembling the actuator to a main body using an actuator product, there are many problems such as assembly tolerance and supply of parts.

A swivel actuator according to the present invention includes a drive motor, a gear train, and a rotating body, which are integrally formed, to thereby achieve miniaturization and slimness while solving the problems of conventional technology.

In addition, a hollow swivel actuator according to the present invention is formed in a disc shape, and includes a through hole for withdrawing a cable, which is formed in a central portion thereof as an inner hollow shape, and a plurality of coupling holes, for example, four coupling holes, which are formed on an upper portion of a rotating body (a rotary table) so as to be connected to a passive object, in which a lower end portion of a fixing bolt passes through each of the coupling holes so as to be screw-coupled to and fixed to a stud nut fixedly installed on an inner surface of the rotary table.

Moreover, the hollow swivel actuator according to this invention may minimize backlash and suppress vibration generation by installing a BLDC-type drive motor on the bottom of a housing and placing, in a symmetrical structure inside the housing, first and second gear trains in which a worm wheel and worm gear are integrally formed at intervals on a power transmission shaft.

The swivel actuator has an annular stator arranged on the bottom of the housing and a rotor arranged therein and having a rotor worm gear integrally formed on the upper side thereof. The first and second gear trains are coupled to the outer periphery of the rotor worm gear in a symmetrical structure. The worm wheel of the power transmission shaft forming each of the first and second gear trains is gear-coupled to the outer periphery of the rotor worm gear. The four worm gears formed at both end portions of the power transmission shaft are coupled to the worm wheels located at the bottom of each of the four pinion gear units. The four pinion gears located at the top of the four pinion gear units are coupled at four points to the ring gear formed inside the side surface portion of the rotary table, to rotatably drive the rotary table.

As a result, the swivel actuator according to the present invention increases the torque by decelerating the rotational output of the drive motor, couples the first and second gear trains to the rotor worm gear of the drive motor in a symmetrical structure, when transmitting the decelerated output to the rotary table, forms a double worm structure at both end portions of the first and second gear trains, and transfers the rotational force to the ring gear of the rotary table through four pinion gear units in the double worm, to thereby minimize backlash, suppress generation of vibration of the rotary table, and increase destructive strength by increasing brake torque.

The swivel actuator according to the present invention includes a BLDC-based drive motor, a pair of gear trains which increases the torque by deceleration of the rotational power of the drive motor and then transmits the increased torque to the rotary table, four pinion gear units coupled to both end portions of each of the pair of gear trains, and a rotary table coupled at four points by a rotational output of the four pinion gear units to rotate together with the ring gear, wherein a passive body such as a vehicle seat is coupled to the rotary table to rotate together with the rotary table.

In this case, the drive motor, the gear trains, the pinion gear units, and the rotary table are integrally assembled to the housing.

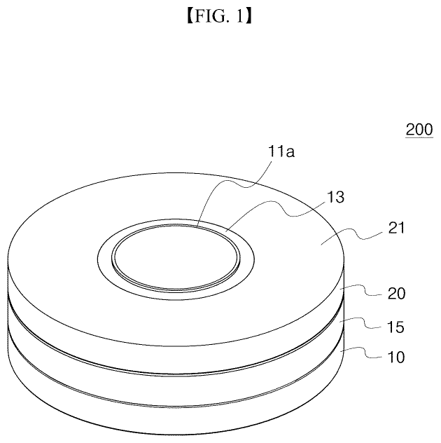

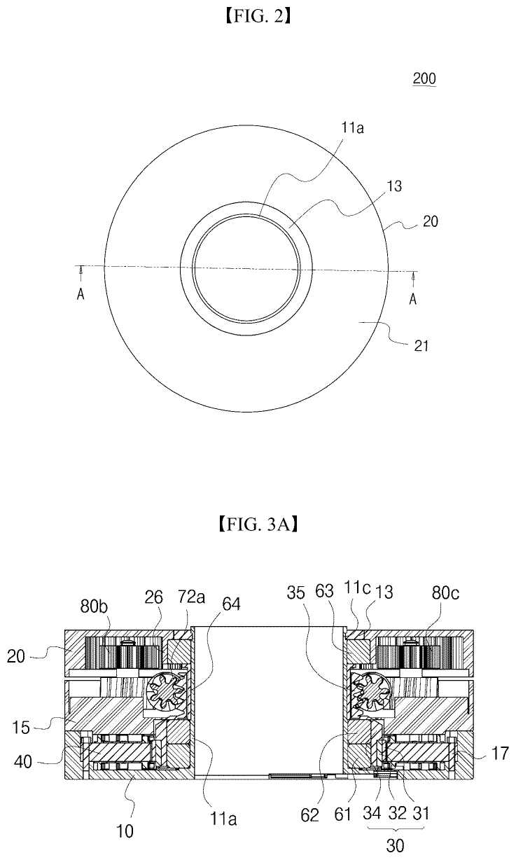

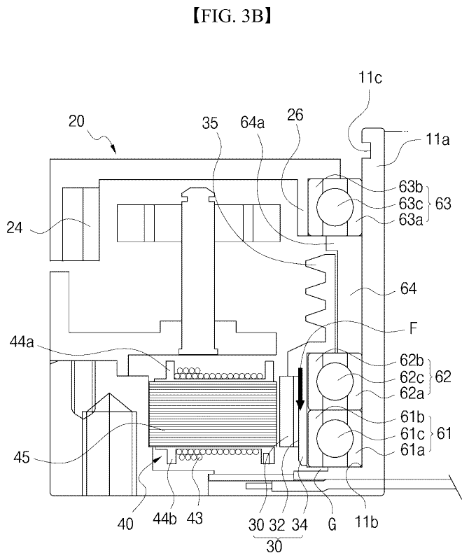

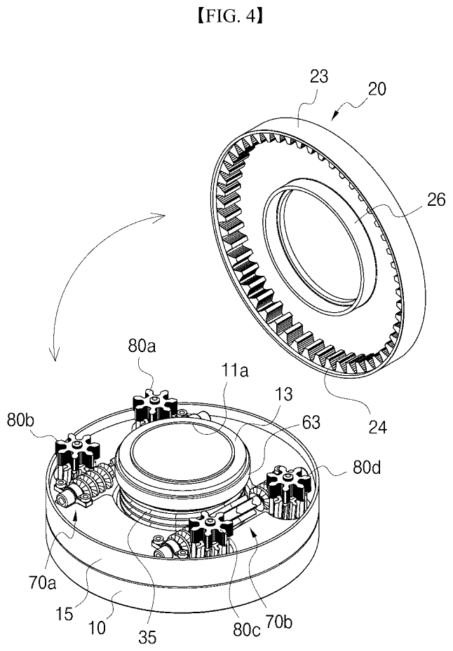

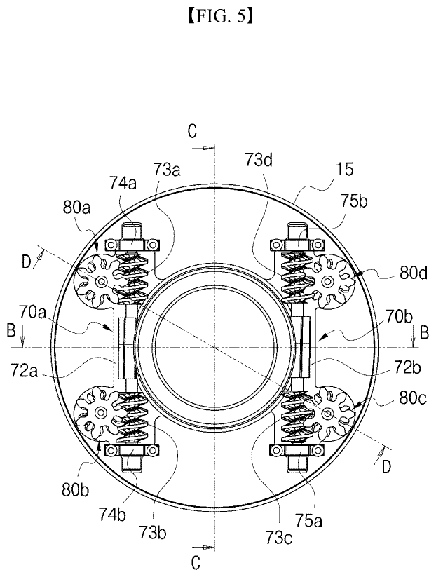

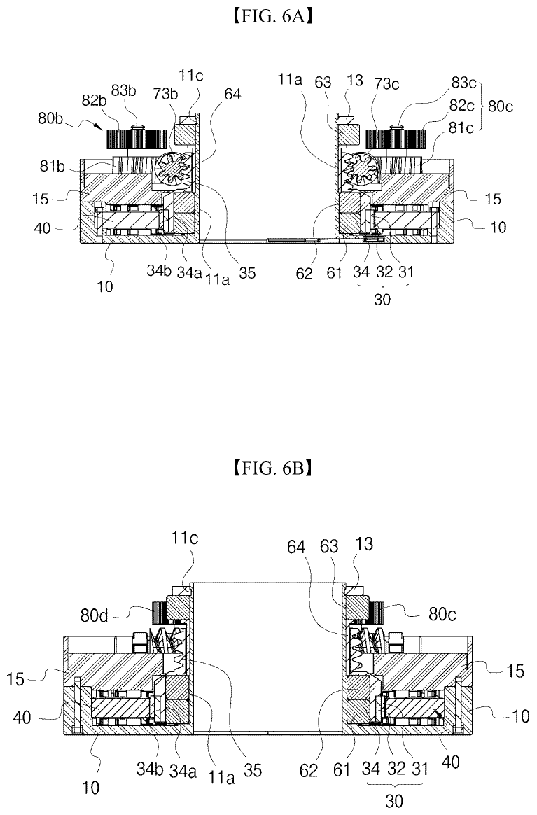

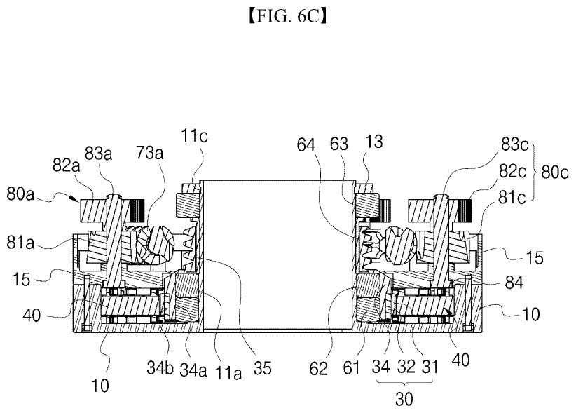

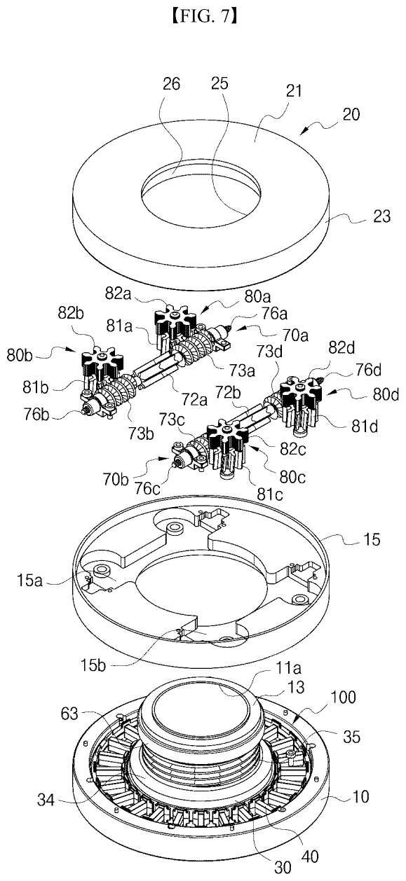

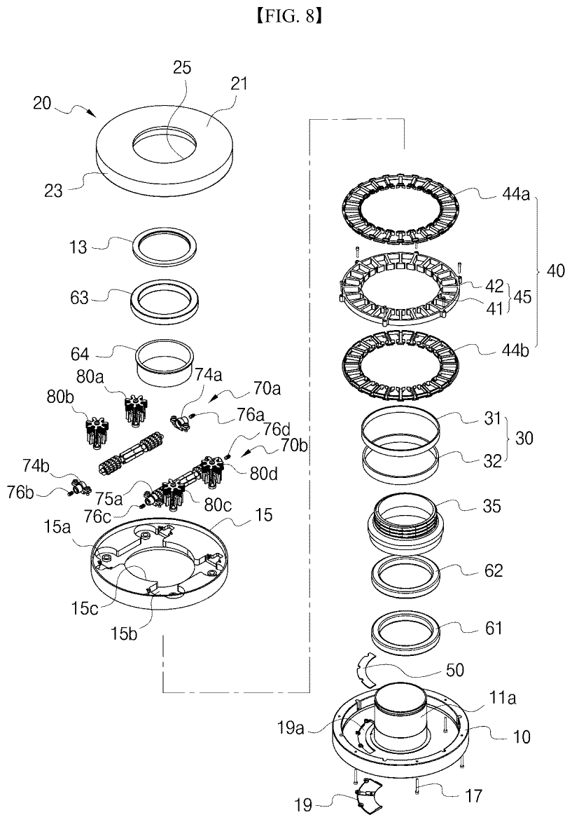

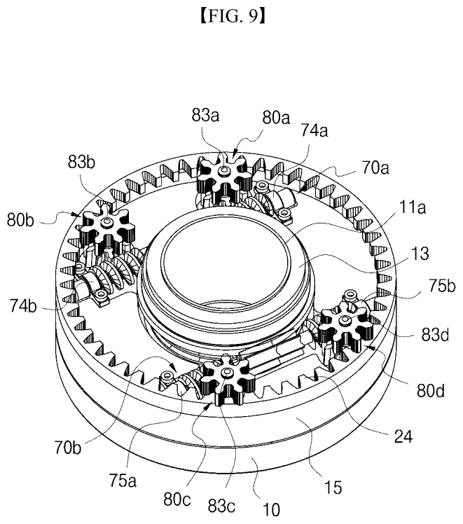

Referring to FIGS. 1 to 10D, a hollow swivel actuator 200 according to a preferred embodiment of the present invention includes: a lower housing 10 having a hollow cylindrical portion 11a protruding upward at a center thereof; an upper housing 15 stacked and assembled on an upper portion of the lower housing 10 and having a through hole 15c formed in a central portion thereof in which the hollow cylindrical portion 11a protrudes upward through the through hole 15c; a drive motor 100 which is arranged on a bottom surface of the lower housing 10 and has a first worm gear 35 integrally formed on an outer periphery of an extension portion of a rotor support 34 extending to an upper portion of the rotor 30; first and second gear trains 70a and 70b which are arranged in the upper housing 15, and coupled to the outer periphery of the rotor worm gear 35 in which first and second worm wheels 72a and 72b gear-coupled to the rotor worm gear 35 are respectively formed at the middle portions of first and second power transmission shafts 71a and 71b, and first to fourth worm gears 73a to 73d are respectively formed at one-side portion and the other-side portion of the first and second power transmission shafts 71a and 71b; first to fourth pinion gear units 80a to 80d in which third to sixth worm wheels 81a to 81d gear-coupled to the first to fourth worm gears 73a to 73d are formed at the lower end portions of first to fourth pinion gear units 80a to 80d, respectively, and first to fourth pinion gears 82a to 82d are formed on the upper end portions of the first to fourth pinion gear units 80a to 80d, respectively; and a rotary table 20 configured to rotate in which the first to fourth pinion gears 82a to 82d of the first to fourth pinion gear units 80a to 80d are gear-coupled to a ring gear 24 integrally formed on the inner side of a side surface portion of the rotary table 20.

The drive motor 100 is installed in the lower housing 10, and a hollow cylindrical portion 11a serving as a support shaft of the rotor 30 protrudes in the center thereof.

In addition, the upper housing 15 is stacked and assembled on the upper portion of the lower housing 10, and a plurality of fixing bolts or screws 17 are fastened and fixed between the upper housing 15 and the lower housing 10. The first and second gear trains 70a and 70b and the first to fourth pinion gear units 80a to 80d are accommodated in the upper housing 15, and a rotary table 20 is rotatably installed above the upper housing 15.

The drive motor 100 generates rotational power, and the first and second gear trains 70a and 70b receive the rotational power and perform torque conversion by decelerating the speed to generate reduced rotational power with increased torque.

Additionally, the first to fourth pinion gear units 82a to 82d are installed vertically on the first to fourth worm gears 73a to 73d of the first and second gear trains 70a and 70b, respectively, to receive reduced rotational power with increased torque, and then transmit the same to the ring gear 24 integrated with the rotational table 20.

The drive motor 100 may be configured as an inner rotor type in which a rotor 30 is arranged inside a stator 40, and includes the rotor 30 rotatably coupled to the outer periphery of the hollow cylindrical portion 11a of the lower housing 10, and the stator 40 arranged at an outer side of the rotor 30 with an air gap therebetween and arranged on a bottom surface of the lower housing 10 to rotate the rotor 30 by generating a rotating magnetic field, wherein the rotor worm gear 35 is integrally formed on the outer peripheral portion of the extension portion of the rotor support 34 extending to the upper portion of the rotor 30.

In the rotor 30, a magnet 31 arranged on the outer periphery of a back yoke 32 located inside the rotor 30, may include a magnet which includes split magnet pieces of a plurality of N-poles and S-poles or a magnet in which N-poles and S-poles are split-magnetized in multiple poles in a ring-shaped magnet. The back yoke 32 is installed on a rear surface of the magnet 31 to form a magnetic circuit.

The rotor 30 includes the rotor support 34, and A lower end portion of the rotor support 34 is formed in a cup shape to rotatably support the rotor 30 on an outer periphery of the hollow cylindrical portion 11a serving as a support shaft, and accommodates first and second bearings 61 and 62 therein, and accommodates the back yoke 32 and the magnet 31 outside the lower end portion thereof.

In this case, the rotor support 34 serves as a bearing housing in which the inner concave groove 34a provided inside the lower end portion thereof accommodates the first and second bearings 61 and 62, and the outer concave groove 34b formed outside the rotor support 34 serves as a support for accommodating the back yoke 32 and the magnet 31.

Furthermore, the rotor support 34 includes a cup-shaped lower end portion supporting the first and second bearings 61 and 62, the back yoke 32, and the magnet 31 inside and outside, and an upper end portion extending upward from the lower end portion through the through hole 15c of the upper housing 15, and a rotor worm gear 35 is integrally formed on the cylindrical outer peripheral portion of the upper end portion. In this case, the rotor worm gear 35 may be integrally formed at an upper end portion of the rotor support 34 to be manufactured by an injection molding method.

The first and second bearings 61 and 62 are stacked up and down in series between the rotor support 34 and the hollow cylindrical portion 11a and stably support the rotor 30.

When stacking a plurality of bearings, it is common to maintain a gap between bearings because there is a gap between adjacent bearings. However, according to the present invention, the first and second bearings 61 and 62 stacked in series without a gap between the bearings support the rotor 30 in a large area, thereby promoting verticality and dimensional stability when the rotor 30 rotates.

The first and second bearings 61 and 62 may be configured as ball bearings in which balls 61c and 62c are inserted between inner races 61a and 62a and outer races 61b and 62b, respectively.

The lower end portions of the inner races 61a and 62a of the first and second bearings 61 and 62 are supported by a stepped portion catching protrusion 11b formed on the outer periphery of the hollow cylindrical part 11a, and the outer races 61b and 62b of the first and second bearings 61 and 62 are supported by an inner concave groove 34a provided inside the lower end portion of the rotor support 34.

In addition, upper end portions of the inner races 61a and 62a of the first and second bearings 61 and 62 may be supported and fixed to the stepped portion catching protrusion 11b by press-fitting the bearing support 64 to the hollow cylindrical portion 11a.

Further, a rotor worm gear separation preventing protrusion 64a is protruded from the upper end portion of the bearing support 64 to prevent the rotor worm gear 35 formed on the extension portion of the rotor support 34 from being separated.

The rotor worm gear 35 rotates in a radial direction in a clockwise (CW) or counterclockwise (CCW) direction, but receives a force up and down.

In the rotor worm gear 35, the rotor 30 may be separated from the first and second bearings 61 and 62 by an up-and-down force to make a touch with the third bearing 63. In order to prevent such a touch from occurring, it is preferable that the bearing support 64 be provided with a rotor worm gear separation prevention protrusion 64a.

In general, in order to increase reliability and reduce noise with respect to a bearing, a spring or a wave washer is used to twist an inner race and an outer race of the bearing, thereby performing a design of applying a preload to the bearing.

In the present invention, instead of employing a structure in which the magnet 31 of the rotor 30 and the stator core 45 face each other on a one-to-one basis, the magnet 31 of the rotor 30 is positioned in an asymmetric structure upward by a predetermined height from the stator core 45.

In this case, the inner races 61a and 62a and the outer races 61b and 62b of the first and second bearings 61 and 62 may be twisted by using a force that causes the outer races 61b and 62b of the first and second bearings 61 and 62 integrally formed with the rotor 30 to move downward by an attractive force acting between the magnet 31 of the rotor 30 and the stator core 45, thereby providing preloads to the bearings as indicated by an arrow F. As a result, the preloads may be applied to the bearings, thereby increasing the reliability of the bearing and reducing noise.

In addition, since the preloads may be applied to the bearings according to the present invention, it is preferable to design to form a predetermined gap G between the lower end portions of the outer races 61b and 62b and the bottom of the lower housing 10 in order to avoid the outer races 61b and 62b of the first and second bearings 61 and 62 from coming into contact with the bottom of the lower housing 10.

The stator 40 includes: a stator core 45 having a plurality of teeth 41 each having a “T” shape and a back yoke 42 interconnected with the plurality of teeth 41 to form a magnetic circuit; upper and lower insulators 44a and 44b made of insulating material, which are integrally formed to surround the outer circumferential surface on which coils 43 of each of the plurality of teeth are wound; and the coil 43 wound around the outer circumferential surfaces of the insulators 44a and 44b.

In this case, the insulator 44a and 44b may be integrally formed as a bobbin and a stator support surrounding the back yoke 42 along with the plurality of teeth 41.

The swivel actuator 200 according to this invention may include the BLDC motor with a 20 pole-18 slot structure, for example, as the drive motor 100. In addition, when the coil 43 of the stator 40 is wound on the plurality of teeth 41, the drive motor 100 may be configured to wind the coil 43 in a U, V, and W three-phase structure, and the other end portions of the U, V, and W three-phase coils 43 may be connected in a star-connection method. Moreover, the drive motor 100 may be driven by a 6-step full-wave driving method using an inverter after receiving a rotor position signal from two or three Hall sensors, for example, in a motor driving circuit.

The first and second gear trains 70a and 70b are respectively arranged in the first and second concave grooves 15a and 15b formed to face each other with respect to the hollow cylindrical portion 11a protruding upward through a through hole 15c positioned at the center of the upper housing 15 stacked and assembled on the upper portion of the lower housing 10.

The first and second gear trains 70a and 70b include first and second power transmission shafts 71a and 71b arranged to face each other at intervals of 180 degrees on the outer periphery of the rotor worm gear 35, first and second worm wheels 72a and 72b that are gear-coupled to the rotor worm gear 35 in the middle of the first and second power transmission shafts 71a and 71b, and first to fourth worm gears 73a to 73d formed on one-side portions and the other-side portions of the first and second power transmission shafts 71a and 71b, respectively.

Both end portions of each of the first and second power transmission shafts 71a and 71b are rotatably supported by a pair of bearings 74a and 74b and a pair of bearings 75a and 75b, respectively, and the first and second concave grooves 15a and 15b have a concave groove shape that accommodates the first and second gear trains 70a and 70b and the first to fourth pinion gear units 80a to 80d.

In this case, in the present invention, set screws 76a to 76d are added to the rear end portions of the bearing housings, respectively, to prevent the first and second power transmission shafts 71a and 71b from causing left and right displacements in the bearing housings supporting two pairs of bearings 74a, 74b, 75a and 75b to limit the left and right displacements of the first and second power transmission shafts 71a and 71b.

Each of the set screws 77a to 77f may have a male thread formed on the outer periphery of the body, a “−” or “+” concave groove may be formed at the rear end portion to accommodate the front end portion of the driver, and the front end portion thereof may be curved or flat.

Each of the set screws 76a to 76d is screw-coupled to a female thread formed in a through hole penetrating inward from the rear end portion of each of the bearing housings, and the front end portions of the six set screws 76a to 76d are coupled in a manner of pushing and compressing both end portions of each of the first and second power transmission shafts 71a and 71b.

The set screws 76a to 76d may be preferably installed in all four bearing housings of the four bearings 74a, 74b, 75a, and 75b that rotatably support both end portions of the first and second power transmission shafts 71a and 71b, or the set screws 76a to 76d may be installed only in one-side portions of the bearing housings to support one-end portions of the first and second power transmission shafts 71a and 71b to push the first and second power transmission shafts 71a and 71b in one direction to suppress the left and right displacements thereof.

The set screws 76a to 76d may have front end portions protruding in a spherical shape to minimize contact with the end portions of the first and second power transmission shafts 71a and 71b. Alternatively, it is also possible to use the set screws 76a to 76d having front end portions in a surface shape. In this invention, since the round per minute (rpm) of the drive motor 100 is few and the gear ratio thereof is large, the shapes of the front end portions of the set screws 76a to 76d are not significantly influential.

The first to four pinion gear units 80a to 80d are installed in the first to fourth support shafts 83a to 83d having lower end portions installed through the bottom of the upper housing 15, the third to sixth worm wheels 81a to 81d gear-coupled to the first to fourth worm gears 73a to 73d are formed in lower end portions of the first to fourth support shafts 83a to 83d, respectively, and the first to fourth pinion gears 82a to 82d are formed in upper end portions of the first to fourth support shafts 83a to 83d, respectively.

The first to fourth pinion gear units 80a to 80d may rotatably support the first to fourth pinion gears 82a to 82d and the third to sixth worm wheels 81a to 81d integrally formed by injection molding using a synthetic resin on the first to fourth support shafts 83a to 83d.

Meanwhile, in the present invention, after the support shaft is assembled through the bottom of the upper housing 15, the worm wheel and the pinion gear sintered and formed on the upper portion of the support shaft are sequentially assembled, and a stopper such as a snap ring or a stopper ring is coupled to the annular concave groove formed in the upper end portion thereof to prevent separation of the worm wheel and the pinion gear. In this case, since the polygonal outer peripheral portions of the third to sixth worm wheels 81a to 81d are coupled to the polygonal inner circumferential portions of the first to fourth pinion gears 82a to 82d connected to the ring gear 25, the torsional force may be maximally implemented, and thus the rotational force of the drive motor 100 may be effectively transmitted to the rotary table 20.

Each of the first to fourth support shafts 83a to 83d has a two-stage structure in which a stopper flange 84 is formed at a lower end portion thereof, and is installed to pass through the bottom of the upper housing 15.

In this case, it is preferable that a locking recess of the stopper flange 84 is formed in the through hole. In this case, when the first to fourth pinion gears 82a to 82d and the third to sixth worm wheels 81a to 81d forming the first to fourth pinion gear units 80a to 80d are rotated, the main force is received in the radial direction, but when a force is applied in the axial direction, the first to fourth support shafts 83a to 83d may be prevented from being separated.

The rotary table 20 has the circular upper plate 21 and the side surface portion 23 extending downward from the outer periphery of the upper plate 21. The upper plate 21 has a plurality of coupling holes which are penetratively formed for coupling with a main body, which is a passive body (e. g., electric seat) installed in the rotary table 20.

A central through hole 25 through which a cable for connecting to a motor driving circuit installed outside the swivel actuator 200 passes from a stator coil 43 of the drive motor 100 and a plurality of Hall sensors provided in the Hall sensor assembly 50 is formed at the center of the upper plate 21.

Accordingly, the cable is introduced downward through the central through hole 25 provided in the center of the upper plate and the hollow cylindrical portion 11a of the lower housing 10, and then connected to a stator coil 43 and a Hall sensor assembly 50 through a through hole 19a formed at the bottom of the lower housing 10. The through hole 19a is finished by being assembled with a through hole cover 19.

In this case, the motor driving circuit may be embedded in a space formed under the housing.

Moreover, the upper end portion of the hollow cylindrical portion 11a of the lower housing 10 is located in the central through hole 25, and a third bearing 63 of a ball bearing structure may be installed in the center of the inner circumferential surface of the upper plate 21 to rotatably support the rotary table 20 to the outer periphery of the hollow cylindrical portion 11a.

In this case, the outer race 63b of the third bearing 63 is supported by the bearing housing 26 protruding from the lower portion of the rotary table 20, and the inner race 63a of the third bearing 63 is supported by the hollow cylindrical portion 11a of the lower housing 10 while the lower end portion thereof is located in the upper end portion of the bearing support 64.

Furthermore, the hollow swivel actuator 200 has a stopper insertion concave groove 11c formed at the upper end portion of the hollow cylindrical portion 11a, and a stopper 13 is coupled to the stopper insertion concave groove 11c to prevent the rotary table 20 from being separated.

A ring gear 24 is integrally formed inside the side surface portion 23 of the rotary table 20, and first to fourth pinion gears 82a to 82d of the first to fourth pinion gear units 80a to 80d are gear-coupled to the ring gear 24.

As described above, the present invention provides a power transmission structure capable of minimizing backlash due to a gear train change structure that minimizes the number of coupled gears, by arranging the first and second worm wheels 72a and 72b in each of the first and second power transmission shafts 71a and 71b, and forming the first to fourth worm gears 73a to 73d in an integral form at intervals in each of the first and second power transmission shafts 71a and 71b.

As a result, the present invention may reduce overall size and secure a space compared to a conventional gear train in which a plurality of spur gears are combined, thereby increasing degree of freedom in design and reducing costs.

In addition, in the present invention, the BLDC drive motor 100 is installed on the bottom of the lower housing 10, and the first and second gear trains 70a and 70b are arranged inside the upper housing 15 assembled above the lower housing 10 to face each other at an interval of 180 degrees, to minimize backlash and suppress vibration generation. Here, the first and second gear trains 70a and 70b are configured so that the first and second worm wheels 72a and 72b and the first to fourth worm gears 73a to 73d are integrally formed at intervals with the first and second power transmission shafts 71a and 71b.

In this invention, as described above, the first to fourth worm gears 73a to 73d are integrally formed to have a double worm structure at both end portions of each of the first and second power transmission shafts 71a and 71b while evenly arranging and combining the two first and second gear trains 70a and 70b at 180 degrees intervals to the rotor worm gear 35 of the drive motor 100, and the first to fourth worm gears 73a to 73d are gear-coupled at four points in the ring gear 24 using the four third to sixth worm wheels 81a to 81d of the first to fourth pinion gear units 80a to 80d and the first to fourth pinion gears 82a to 82d thereof.

As a result, in the present invention, as a double worm structure is adopted at either end portion of each of the first and second gear trains 70a and 70b, the four pinion gear units 80a to 80d are combined with the four worm gears 73a to 73d to drive the rotary table 20, thereby increasing the fracture strength while increasing the brake torque while minimizing the backlash.

As described above, when the first and second gear trains 70a and 70b are arranged inside the upper housing 15, it is possible to reduce a tolerance between gears, but it is difficult to completely reduce the tolerance. That is, a gap between the gears is minimized but a tolerance between gears is generated to form a gap, and thus the rotary table 20 gear-coupled to the first to fourth pinion gears 82a to 82d and the passive object to be driven thereon may be shaken in the left and right directions.

This problem may be caused by the occurrence of the left and right displacement of both end portions of the power transmission shafts forming the gear train in the bearing housing. In this invention, both end portions of each of the first and second power transmission shafts 71a and 71b are rotatably supported by four bearings 74a, 74b, 75a and 75b, respectively.

The four bearings 74a, 74b, 75a, and 75b are embedded in the four bearing housings fixedly installed in the first and second concave grooves 16a and 16b formed on the bottom of the upper housing 15. In this invention, four set screws 76a to 76d are added to the rear end portions of the bearing housings so that both end portions of each of the first and second power transmission shafts 71a and 71b suppress the occurrence of left and right displacements in the bearing housings.

As a result, the left and right displacements of the first and second power transmission shafts 71a and 71b are suppressed to eliminate a tolerance (gap) generated when the first to fourth worm gears 73a and 73d of the first and second gear trains 70a and 70b and the third to sixth worm wheels 81a to 81d of the first to fourth pinion gear units 80a to 80d are gear-coupled with each other. In addition, the gap between the first to fourth pinion gears 82a to 82d of the first to fourth pinion gear units 80a to 80d and the ring gear 24 of the rotary table 20 may be removed to zero the backlash.

The compression between the set screws 76a to 76d and the first and second power transmission shafts 71a and 71b may suppress the left and right movements of the first and second power transmission shafts 71a and 71b by assembling the first and second power transmission shafts 71a and 71b inside the upper housing 15, and then pushing the first and second power transmission shafts 71a and 71b by advancing the set screws 76a to 76d in one direction.

Hereinafter, an operation of the inner hollow swivel actuator 200 according to the present invention will be described with reference to FIGS. 1 to 10D.

When the BLDC drive motor 100 installed on the bottom of the lower housing 10 is operated in the hollow swivel actuator 200 of this invention, the rotor 30 rotates and the rotor worm gear 35 formed integrally on the upper side of the rotor support 34 of the rotor 30 rotates in the same direction.

When the rotor worm gear 35 rotates, the first and second worm wheels 72a and 72b of the first and second gear trains 70a and 70b, which are arranged at intervals of 180 degrees on the outer periphery of the rotor worm gear 35, rotate, and the first and second power transmission shafts 71a and 71b also rotate.

As a result, the first to fourth worm gears 73a to 73d formed on the other-side portions of the first and second power transmission shafts 71a and 71b rotate the third to sixth worm wheels 81a to 81d of the first to fourth pinion gear units 80a to 80d to be gear-coupled to the first to fourth worm gears 73a to 73d.

Accordingly, the first to fourth pinion gears 82a to 82d located at the upper end portions of the first to fourth pinion gear units 80a to 80d are rotated and driven, and the first to fourth pinion gears 82a to 82d are gear-coupled to the ring gear 24 provided on the rotary table 20 at intervals of 90 degrees to rotate the ring gear 24 in the same direction.

In the present invention, when the BLDC drive motor 100 is rotated at about 800 rpm, the BLDC drive motor 50 is decelerated to approximately 400:1 through the first and second gear trains 70a and 70b, and the rotary table 20 is reduced in rotating speed at a low speed of about 2 rpm, resulting in an increase in a large torque.

As described above, as the present invention adopts a double worm structure at either end portion of each of the first and second gear trains 70a and 70b while arranging the first and second gear trains 70a and 70b in a symmetrical structure inside the upper housing 15, four pinion gear units 80a to 80d are coupled to the four worm gears 73a to 73d to drive the rotary table 20, thereby increasing the fracture strength by increasing the break torque while minimizing the backlash.

In addition, in the present invention, the set screws 77a to 76d are added to the set screw assembly units extending from the rear end portions of the bearing housings so that both end portions of each of the first and second power transmission shafts 71a and 71b suppress left and right displacement from occurring in the bearing housings 78a to 78d.

In the present invention, after assembling all the components of the swivel actuator 200 inside the upper housing 15, one for each of the first and second power transmission shafts 71a and 71b, that is, two of the four set screws 76a to 76d installed in a set screw assembly unit are advanced in one direction, from the outside through a set screw adjustment through hole (not shown) formed in the wall of the upper housing 15, thereby suppressing the left and right movement of the first and second power transmission shafts 71a and 71b by pushing and fixing the first and second power transmission shafts 71a and 71b to one side.

As a result, the left and right displacements of the first and second power transmission shafts 71a and 71b are suppressed by tightening the set screws 76a to 76d, to thereby eradicate a tolerance (gap) which may be generated during gear-coupling between the first to fourth worm gears 73a to 73d of the first and second gear trains 70a and 70b and the third and sixth worm wheels 81a to 81d of the first to fourth pinion gear units 80a to 80d. In addition, the gap between the first to fourth pinion gears 82a to 82d of the first to fourth pinion gear units 80a to 80d and the ring gear 24 of the rotary table 20 may be removed to zero the backlash.

While the present invention has been particularly shown and described with reference to exemplary embodiments thereof, by way of illustration and example only, it is clearly understood that the present invention is not to be construed as limiting the present invention, and various changes and modifications may be made by those skilled in the art within the protective scope of the invention without departing off the spirit of the present invention.

### INDUSTRIAL APPLICABILITY

The swivel actuator according to the present invention may be applied for rotating a passive object such as a car seat installed on a rotary table so as to rotate left and right together with the rotary table.

What is claimed is:

1. A drive motor for a swivel actuator, the drive motor comprising:
a housing having a hollow cylindrical portion protruding from a bottom thereof at a center thereof;
a rotor having a rotor support having a cup shape at a lower end portion thereof, and rotatably coupled to an outer periphery of the hollow cylindrical portion;
a stator which is arranged on the outer side of the rotor with an air gap, generates a rotating magnetic field, and is arranged on the bottom of the housing to rotate the rotor;
first and second bearings arranged between the cup-shaped lower end portion of the rotor support and a lower end portion of the hollow cylindrical portion to rotatably support the rotor, and stacked in series; and
a bearing support press-coupled to the outer periphery of the hollow cylindrical portion to press the second bearing.

2. The drive motor of claim 1, wherein the rotor support comprises:
an inner concave groove provided inside the lower end portion thereof to serve as a bearing housing for accommodating the first and second bearings; and
an outer concave groove formed outside the lower end portion thereof to serve as a support for accommodating a back yoke and a magnet of the rotor, wherein each of the first and second bearings is configured as a ball bearing in which an inner race is supported by the hollow cylindrical portion and an outer race is supported in the inner concave groove.

3. The drive motor of claim 1, wherein the bearing support is pressed and coupled to the outer periphery of the hollow cylindrical portion to compress the inner race of the second bearing.

4. The drive motor of claim 1, wherein a preload is applied to the first and second bearings by positioning the magnet of the rotor in an asymmetric structure upward by a predetermined height from the stator core.

5. The drive motor of claim 1, further comprising a rotor worm gear separation prevention protrusion protruding from the upper end portion of the bearing support to prevent the rotor from separating from the first and second bearings and making contact with the third bearing.

6. The drive motor of claim 1, further comprising a rotor worm gear integrally formed on the upper portion of the rotor support extending above the rotor.

7. A swivel actuator comprising:
a lower housing with a hollow cylindrical portion protruding upward in the center thereof, which serves as a support shaft of the rotor;
an upper housing stacked and assembled on an upper portion of the lower housing and having a through hole formed in a central portion thereof in which the hollow cylindrical portion protrudes upward through the through hole;
a drive motor which is arranged on a bottom surface of the lower housing and has a rotor worm gear integrally formed on an outer periphery of a cylindrical extension portion of the rotor support extending to an upper portion of the through hole;
first and second gear trains, each being arranged at intervals of 180 degrees at the outer periphery of the rotor worm gear protruding to the upper housing and being coupled thereto, having, in the middle of first and second power transmission shafts, first and second worm wheels gear-coupled to the rotor worm gear, and having first to fourth worm gears formed at both sides of each of the first and second power transmission shafts;
first to fourth pinion gear units in which third to sixth worm wheels gear-coupled to the first to fourth worm gears are formed at the lower end portions of first to fourth support shafts, respectively, and first to fourth pinion gears are formed on the upper end portions of the first to fourth support shafts, respectively;
a rotary table gear-coupled to a ring gear having the first to fourth pinion gears integrally formed on the inner side of the side surface portion thereof, so as to rotate;
first and second bearings arranged between the cup-shaped lower end portion of the rotor support and a lower end portion of the hollow cylindrical portion to rotatably support the rotor, and stacked in series; and
a third bearing rotatably supporting the rotary table on an outer periphery of an upper end portion of the hollow cylindrical portion.

8. The swivel actuator of claim 7, wherein the first and second gear trains comprises:
first and second power transmission shafts arranged to face each other at intervals of 180 degrees on the outer periphery of the rotor worm gear;
first and second worm wheels that are gear-coupled to the rotor worm gear in the middle portions of the first and second power transmission shafts; and
first to fourth worm gears formed on one side and the other side of each of the first and second power transmission shafts.

9. The swivel actuator of claim 8, wherein each of the first and second power transmission shafts further comprises:
a pair of bearings installed in first and second concave grooves of the upper housing respectively to rotatably support both end portions;
a pair of bearing housings that accommodate and support the pair of bearings; a pair of set screw assembly units formed to extend from the rear end portions of the pair of bearing housings; and
a pair of set screws which are screw-coupled to the set screw assembly units so that front end portions thereof support end portions of the power transmission shafts, wherein
the set screws suppress axial displacement of the first and second power transmission shafts by pushing and fixing the first and second power transmission shafts to one side from the outside through set screw adjustment through holes formed in the upper housing.

10. The swivel actuator of claim 8, wherein
the rotor of the drive motor is rotatably installed on the outer periphery of the hollow cylindrical portion,
the rotor worm gear is arranged in a vertical direction, the first and second power transmission shafts are arranged in a horizontal direction, and the first to fourth support shafts are arranged in a vertical direction.

11. The swivel actuator of claim 8, wherein the rotary table comprises:
a top plate on which a car seat is installed, and which is equipped with a through hole in the center where the upper end portion of the hollow cylindrical portion of the lower housing is located;
a side surface portion extending downward from an outer circumferential portion of the upper plate; and
a ring gear integrally formed inside the side surface portion,
wherein the first to fourth pinion gears of the first to fourth pinion gear units are gear-coupled to the ring gear of the rotary table at four points.

12. The swivel actuator of claim 8, further comprising a bearing support press-coupled to the outer periphery of the hollow cylindrical portion to press the second bearing.
